(19) United States
(12) Patent Application Publication
(10) Pub. No.: US 2025/0313712 A1
(43) Pub. Date: Oct. 9, 2025

(54) OPTICALLY READABLE PHYSICAL UNCLONABLE FUNCTIONS

(71) Applicant: QUANTUM BASE LIMITED, Stockport Cheshire (GB)

(72) Inventors: Benjamin Robinson, Stockport Cheshire (GB); Phillip Speed, Stockport Cheshire (GB); David Ian Howarth, Stockport Cheshire (GB); Robert James Young, Stockport Cheshire (GB); Angelo Lamantia, Stockport Cheshire (GB)

(21) Appl. No.: 18/867,904

(22) PCT Filed: May 23, 2023
(86) PCT No.: PCT/GB2023/051343

§ 371 Date: Nov. 21, 2024

(30) Foreign Application Priority Data
May 26, 2022 (GB) 2207791.1
May 23, 2023 (WO) PCT/GB2023/051343

(51) Int. Cl. C09D 11/50; C09D 11/033; C09D 11/037; C09K 11/06; H04L 9/32

(52) U.S. Cl. CPC C09D 11/50; C09D 11/033; C09D 11/037; C09K 11/06; H04L 9/3278; C09K 2211/1007; C09K 2211/1018

(57) ABSTRACT

(b) There is provided a method of making an optically readable PDF coating composition, the method comprising increasing the entropy of the coating composition by adding an optically readable material and optionally a solvent to at least two portions of the coating composition and then combining the portions of the coating composition.

The present inventive relates generally to optically readable physical unclonable functions (PUFs), methods of preparing optically readable PUFs, and articles containing optically readable PUFs.

There is often a need to prove, or disprove, the authenticity of an object or similar. For instance, this might be needed for security purposes, for example to allow or prevent access to certain functionality associated with the object, or simply to allow a user or consumer of the object to be satisfied that they are using an authentic object. It will be appreciated that such tests for authenticity find use in the fields of anti-counterfeiting, security and so on.

In order to be able to prove that an object is an authentic object, or in other words to authenticate an object, that object might be provided with a unique identifier in one form or another. “Unique” might not necessarily mean that it is impossible for another object to have the same identifier, but instead that it is statistically highly unlikely for this to be the case, or in other words for the identifier to be accidentally stumbled across by guesswork or simple trial and error. The very same “uniqueness” might be used in other ways, too, for example for highly targeted marketing or data acquisition with respect to the object or a user or consumer of that object.

A unique identifier might, for example, take the form of or be derived from a physical (sometimes referred to as physically) unclonable function (a PUF). This might be in the form of a device or other element, the properties of which depend on small variations in construction or fabrication or similar, but which nevertheless can be used to provide a unique identifier. For instance, in a vast array of memory cells, a certain number of memory cells may be defective, and this number or arrangement of defective cells will be different for different arrays that are produced. Thus, this is a simple example of a unique identifier. Another example might be, for instance, a capacitance or resistance of an electrical component, based on the thickness of layers within that component, or the extent of those layers, and so on. Due to tolerances in manufacturing, each component will likely have a slightly different construction, and so a slightly different, and unique, electrical property.

Unique identifiers do not necessarily need to be based on electrical principles. For instance, physical unclonable functions may be probed or otherwise challenged optically in order to determine a unique identifier. For instance, the way in which one or more optical emitters are provided on an object may, as above, yield an overall emission spectrum or map which is unique, again providing a readable unique identifier.

Traditionally, the generation of unique identifiers, and/or associated use of physical unclonable functions, have been based on macroscopic effects. More recently though, it has been proposed to incorporate quantum mechanical effects in the generation of unique identifiers. In these more recent examples, for instance, an electrical component exhibiting quantum mechanical confinement (e.g. a resonant tunnelling diode) may be used as a quantum mechanical based physical unclonable function. The electrical properties of such a device or structure, and thus the unique identifier, are based on quantum mechanical principles. Similarly, optical based physical unclonable functions may be based on the emissions spectra of quantum dots, or 2-D materials, or similar, located on an object. In both cases, it may be extremely difficult, if not impossible, to be able to physically copy a security element (e.g. being or comprising a physical unclonable function) based on quantum mechanical effects. This is to the extent that the unique identifier provided by such an element may not be circumvented, and certainly not in any practical timeframe.

It is an example aim or example embodiments of the present invention to at least partially overcome or avoid one or more disadvantages of the prior art, whether identified herein or elsewhere, or to at least provide a viable alternative.

According to the present invention there are provided products and methods as set forth in the claims that follow. Other features of the invention will be apparent from the dependent claims, and the description which follows.

According to a first aspect of the present invention, there is provided a method of making an optically readable PUF coating composition, the method comprising increasing the entropy of a coating composition by adding a first optically readable material to the coating composition.

By “optically readable PUF coating composition” is meant a composition which, when coated onto a substrate, provides an optically readable PUF (i.e. physical unclonable function). The optically readable PUF can be used to provide a unique identifier which can be verified by optical means. The properties of the optically readable PUF may depend on small variations in construction or fabrication or similar.

By “entropy” is meant the degree of randomness or non-uniformity of distribution of components in the coating composition. Entropy may be measured by the uniformity of an optically readable PUF prepared from the optically readable PUF coating composition, as described in the examples.

The method of the first aspect advantageously provides an optically readable PUF coating composition which comprises a random, non-uniform distribution of an optically readable material. This may provide an optically readable PUF with improved properties, such as uniqueness and readability while maintaining the coatability of the coating composition. The method of the first aspect is surprising as typically, coating compositions with minimum entropy are desirable.

The method of the first aspect may also allow an optically readable PUF to be produced which does not necessarily rely on quantum mechanical effects. Therefore the optically readable PUF coating composition may be more cheaply or easily produced using widely available starting materials.

Prior to addition of the optically readable material, the coating composition suitably does not provide an optically readable PUF when coated onto a substrate. For example, the coating composition may be free or substantially free of the first optically readable material. By “substantially free”, we mean that the coating composition comprises no more than trace amounts of the first optically readable material.

The coating composition may comprise a solvent. The solvent may comprise a polar solvent and/or a non-polar solvent. Preferably the solvent comprises a polar solvent. The solvent may comprise an organic solvent and/or an inorganic solvent. The solvent may comprise a mixture of an organic solvent and an inorganic solvent, such as water. Preferably the solvent comprises an organic solvent. The organic solvent suitably comprises a polar organic compound having 6 or fewer carbon atoms. The organic solvent may comprise an alcohol and/or a ketone. Suitable examples of organic solvents include ethanol, propanol, isopropyl alcohol and acetone. Ethanol is preferred.

The coating composition suitably comprises a polymer. The polymer may act as a binder to allow the coating composition, and any further components in the composition, to adhere to a substrate and form a coating layer. The polymer may be liquid. Alternatively, in embodiments where the coating composition comprises a solvent, the polymer may be dissolved in the solvent.

The coating composition may be curable (for example when the coating composition comprises a liquid polymer) or air-dryable (for example when the coating composition comprises a polymer dissolved in a solvent). The coating composition may be thermally curable, UV curable, air curable, or chemically curable. By “chemically curable”, we mean that the coating composition is cured by mixing a curing agent into the composition. Suitably the curing agent is mixed into the coating composition just prior to application of the composition to a substrate. Preferably the coating composition is UV curable.

The coating composition is suitably a lacquer. By “lacquer” we mean a coating composition which forms a clear coating. Using a lacquer as the coating composition makes it easier to read the optically readable PUF obtained when the optically readable PUF coating composition provided by the method of the first aspect is coated onto a substrate. The first optically readable material is advantageously more visible in a clear coating.

The lacquer may be curable or air-dryable. The lacquer may be thermally curable, UV curable, air curable, or chemically curable. Preferably the lacquer is UV curable.

The first optically readable material may comprise any suitable material that can be detected by optical means. The first optically readable material may comprise a quantum dot, a quantum wire, a flake or layer of a substantially two-dimensional material, a metallic nanoparticle, a coloured compound and/or a fluorescent compound. Preferably, the first optically readable material comprises a quantum dot, a quantum wire, a flake or layer of a substantially two-dimensional material, a metallic nanoparticle, and/or a fluorescent compound. The first optically readable material may emit electromagnetic radiation at a single wavelength, or the first optically readable material may emit electromagnetic radiation with different wavelengths, for example corresponding to a variation in band gap of the first optically readable material. The first optically readable material may therefore be an emitter of electromagnetic radiation, or in other words a material configured or generally able to emit electromagnetic radiation when excited, for example by excitation electromagnetic radiation.

In some embodiments, the first optically readable material comprises a quantum dot, a quantum wire, a flake or layer of substantially two-dimensional material, and/or a metallic nanoparticle. The first optically readable material may comprise a plurality of quantum dots, quantum wires, flakes or layers of two-dimensional material, and/or metallic nanoparticles.

By “substantially two-dimensional material” is meant a material that has a thickness of a few nanometres or less, for example such that motion of electrons into, and out of, a two dimensional plane is governed by quantum mechanical effects.

In some embodiments, the first optically readable material comprises a coloured compound. By “coloured compound” is meant a compound which absorbs electromagnetic radiation in the visible spectrum, e.g. at a wavelength from 400 to 700 nm.

In some embodiments, the first optically readable material comprises a fluorescent compound. The fluorescent compound is an emitter of electromagnetic radiation, or in other words a compound able to emit electromagnetic radiation when excited, for example by excitation electromagnetic radiation.

The fluorescent compound may comprise a small molecule. The fluorescent compound suitably comprises a polyunsaturated compound, for example a polyaromatic compound. Suitable examples of fluorescent compounds include rhodamine dyes, cyanine dyes, phthalocyanine dyes, porphyrin dyes, and quinacridones. Rhodamine dyes and cyanine dyes are preferred. The rhodamine dye may be selected from Rhodamine 6G, Rhodamine 123 and/or Rhodamine B. The cyanine dye may be selected from Cy2, Cy3, Cy3.5, Cy5, C5.5, Cy7 and/or Cy7.5.

10 The first optically readable material may be added to the coating composition in an amount of from 0.1 to 15 mg/mL, such as from 0.5 to 10 mg/mL, such as from 1 to 5 mg/ml based on the total volume of the optically readable PUF coating composition. The first optically readable material may be added to the coating composition in an amount of from 0.01 to 1.5 wt %, such as from 0.05 to 1.0 wt %, such as from 0.08 to 0.4 wt % based on the total weight of the optically readable PUF coating composition.

Suitably, the first optically readable material is poorly soluble or insoluble in the coating composition. The first optically readable material may have a solubility of less than 100 mg/mL, such as less than 50 mg/mL, such as less than 10 mg/mL, for example less than 1 mg/ml in the coating composition at a temperature of 20° C. and a pressure of 100 kPa. Advantageously, adding the first optically readable material to the coating composition when the first optically readable material is poorly soluble or insoluble in the coating composition may result in the clustering or agglomeration of the first optically readable material.

The method of the first aspect suitably comprises non-uniformly dispersing the first optically readable material in the coating composition. The resulting coating composition suitably comprises a non-uniform distribution of the first optically readable material. For example, the resulting coating composition may comprise clusters or agglomerates of the first optically readable material. The first optically readable material may be mixed into the coating composition, but not to an extent that the first optically readable material is uniformly distributed.

The method of the first aspect may comprise adding the first optically readable material to the coating composition without a solvent. In other words, the first optically readable material is not mixed with a solvent before being added to the coating composition. This helps to ensure that the first optically readable material is non-uniformly distributed in the coating composition.

The method of the first aspect may further comprise mixing a second optically readable material and a solvent to form a mixture and adding the mixture to the coating composition.

The second optically readable material may comprise any suitable material that can be detected by optical means. The second optically readable material may comprise a quantum dot, a quantum wire, a flake or layer of a substantially two-dimensional material, a metallic nanoparticle, a coloured compound and/or a fluorescent compound. Preferably, the second optically readable material comprises a quantum dot, a quantum wire, a flake or layer of a substantially two-dimensional material, a metallic nanoparticle, and/or a fluorescent compound. The second optically readable material may emit radiation at a single wavelength, or the second optically readable material may emit radiation with different wavelengths, for example corresponding to a variation in band gap of the second optically readable material. The second optically readable material may therefore be an emitter of electromagnetic radiation, or in other words a material configured or generally able to emit electromagnetic radiation when excited, for example by excitation electromagnetic radiation.

In some embodiments, the second optically readable material comprises a quantum dot, a quantum wire, a flake or layer of substantially two-dimensional material, and/or a metallic nanoparticle. The second optically readable material may comprise a plurality of quantum dots, quantum wires, flakes or layers of two-dimensional material, and/or metallic nanoparticles.

In some embodiments, the second optically readable material comprises a coloured compound.

In some embodiments, the second optically readable material comprises a fluorescent compound. The fluorescent compound is an emitter of electromagnetic radiation, or in other words a compound able to emit electromagnetic radiation when excited, for example by excitation electromagnetic radiation.

The fluorescent compound may comprise a small molecule. The fluorescent compound suitably comprises a polyunsaturated compound, for example a polyaromatic compound.

Suitable examples of fluorescent compounds include rhodamine dyes, cyanine dyes, phthalocyanine dyes, porphyrin dyes, and quinacridones. Rhodamine dyes and cyanine dyes are preferred. The rhodamine dye may be selected from Rhodamine 6G, Rhodamine 123 and/or Rhodamine B. The cyanine dye may be selected from Cy2, Cy3, Cy3.5, Cy5, C5.5, Cy7 and/or Cy7.5.

The first optically readable material and the second optically readable material may be the same or different. Preferably, the first optically readable material is different to the second optically readable material. When the first optically readable material is the same as the second optically readable material, the first optically readable material is suitably optically distinguishable from the second optically readable material in the optically readable PUF coating composition. For example, the difference in the chemical environments of the optically readable materials (such as the medium in which the optically readable materials are dispersed) may result in different emissions.

Suitably, the first optically readable material and/or the second optically readable material comprises a quantum dot, a quantum wire, a flake or layer of a substantially two-dimensional material, a metallic nanoparticle, and/or a fluorescent compound.

Preferably, the first optically readable material and/or the second optically readable material comprises a fluorescent compound. The fluorescent compound may comprise a small molecule. The fluorescent compound suitably comprises a polyunsaturated compound, for example a polyaromatic compound. Suitable examples of fluorescent compounds include rhodamine dyes, cyanine dyes, phthalocyanine dyes, porphyrin dyes, and quinacridones.

Rhodamine dyes and cyanine dyes are preferred. The rhodamine dye may be selected from Rhodamine 6G, Rhodamine 123 and/or Rhodamine B. The cyanine dye may be selected from Cy2, Cy3, Cy3.5, Cy5, C5.5, Cy7 and/or Cy7.5.

Suitably, the second optically readable material is poorly soluble or insoluble in the coating composition. The second optically readable material may have a solubility of less than 100 mg/mL, such as less than 50 mg/mL, such as less than 10 mg/mL, for example less than 1 mg/mL in the coating composition at a temperature of 20° C. and a pressure of 100 kPa. Advantageously, adding the second optically readable material a solvent prior to addition to the coating composition allows the second optically readable material to be uniformly distributed in the coating composition

The solvent mixed with the second optically readable material may comprise a polar solvent and/or a non-polar solvent. Preferably the solvent comprises a polar solvent. The solvent may comprise an organic solvent and/or an inorganic solvent. The solvent may comprise a mixture of an organic solvent and an inorganic solvent, such as water. Preferably the solvent comprises an organic solvent. The organic solvent suitably comprises a polar organic compound having 6 or fewer carbon atoms. The organic solvent may comprise an alcohol and/or a ketone. Suitable examples of organic solvents include ethanol, propanol, isopropyl alcohol and acetone. Ethanol is preferred.

The second optically readable material may be soluble in the solvent. The second optically readable material may have a solubility of at least 1 mg/mL, such as at least 10 mg/mL, such as at least 50 mg/mL, for example at least 100 mg/mL in the solvent at a temperature of 20° C. and a pressure of 100 kPa. The mixture of the second optically readable material and the solvent is suitably a solution.

The second optically readable material and the solvent may be uniformly mixed. The uniform mixing of the second optically readable material in the solvent may advantageously provide the optically readable PUF coating composition with a uniform background emission.

The second optically readable material may be added to the solvent in an amount of from 10 to 500 mg/mL, such as from 50 to 200 mg/mL, such as from 80 to 150 mg/ml based on the total volume of the mixture.

The method of the first aspect may comprise adding a third optically readable material to the mixture of the second optically readable material and the solvent, and adding the mixture to the coating composition.

The third optically readable material may comprise any suitable material that can be detected by optical means. The third optically readable material may comprise a quantum dot, a quantum wire, a flake or layer of a substantially two-dimensional material, a metallic nanoparticle, a coloured compound and/or a fluorescent compound. Preferably, the third optically readable material comprises a quantum dot, a quantum wire, a flake or layer of a substantially two-dimensional material, a metallic nanoparticle, and/or a fluorescent compound. The third optically readable material may emit radiation at a single wavelength, or the third optically readable material may emit radiation with different wavelengths, for example corresponding to a variation in band gap of the third optically readable material. The third optically readable material may therefore be an emitter of electromagnetic radiation, or in other words a material configured or generally able to emit electromagnetic radiation when excited, for example by excitation electromagnetic radiation.

In some embodiments, the third optically readable material comprises a quantum dot, a quantum wire, a flake or layer of substantially two-dimensional material, and/or a metallic nanoparticle. The third optically readable material may comprise a plurality of quantum dots, quantum wires, flakes or layers of two-dimensional material, and/or metallic nanoparticles.

In some embodiments, the third optically readable material comprises a coloured compound.

In some embodiments, the third optically readable material comprises a fluorescent compound. The fluorescent compound is an emitter of electromagnetic radiation, or in other words a compound able to emit electromagnetic radiation when excited, for example by excitation electromagnetic radiation.

The fluorescent compound may comprise a small molecule. The fluorescent compound suitably comprises a polyunsaturated compound, for example a polyaromatic compound. Suitable examples of fluorescent compounds include rhodamine dyes, cyanine dyes, phthalocyanine dyes, porphyrin dyes, and quinacridones. Rhodamine dyes and cyanine dyes are preferred. The rhodamine dye may be selected from Rhodamine 6G, Rhodamine 123 and/or Rhodamine B. The cyanine dye may be selected from Cy2, Cy3, Cy3.5, Cy5, C5.5, Cy7 and/or Cy7.5.

The third optically readable material may be poorly soluble or insoluble in the solvent. The second optically readable material may have a solubility of less than 100 mg/mL, such as less than 50 mg/mL, such as less than 10 mg/mL, for example less than 1 mg/ml in the solvent at a temperature of 20° C. and a pressure of 100 kPa. The mixture of the second optically readable material, the third optically readable material and the solvent is suitably a suspension of the third optically readable material.

The third optically readable material and the solvent may be uniformly mixed. The uniform mixing of the third optically readable material in the solvent may advantageously provide the optically readable PUF coating composition with a uniform background emission.

The third optically readable material may be added to the solvent in an amount of from 10 to 500 mg/mL, such as from 50 to 200 mg/mL, such as from 80 to 150 mg/mL based on the total volume of the mixture.

Preferably, in embodiments where a third optically readable material is added, the second optically readable material is soluble in the solvent and the third optically readable material is insoluble or poorly soluble in the solvent. The physical interactions between the second optically readable material and the third optically readable material advantageously allow the third optically readable material to be uniformly dispersed in the mixture, for example by allowing the third optically readable material to dissolve in the mixture.

The mixture may be added to the coating composition such that the second optically readable material (and third optically readable material, if present) is present in an amount of from 0.1 to 15 mg/mL, such as from 0.5 to 10 mg/mL, such as from 1 to 5 mg/ml based on the total volume of the optically readable PUF coating composition. The mixture may be added to the coating composition such that the second optically readable material (and third optically readable material, if present) is present in an amount of from 0.01 to 1.5 wt %, such as from 0.05 to 1.0 wt %, such as from 0.08 to 0.4 wt % based on the total weight of the optically readable PUF coating composition.

The method of the first aspect suitably comprises uniformly mixing the mixture and the coating composition.

In the method of the first aspect, the first optically readable material may be added to the coating composition prior to the mixture containing the second optically readable material, the third optically readable material, if present, and the solvent. Alternatively, the mixture containing the second optically readable material, the third optically readable material, if present, and the solvent may be added to the coating composition prior to the first optically readable material.

The method of the first aspect may comprise increasing the entropy of the coating composition by adding an optically readable material and optionally a solvent to at least two portions of the coating composition and then combining the portions of the coating composition.

Preparing at least two separate portions of the coating composition which are then combined advantageously allows the uniformity of the optically readable material in each portion to be tuned independently. For example, one portion of the coating composition may comprise a non-uniform distribution of an optically readable material and another portion of the coating composition may comprise a uniform distribution of an optically readable material. Thus, the non-uniform distribution may advantageously be unaffected by the preparation of the uniform distribution.

The optically readable material suitably comprises at least the first optically readable material as defined herein. The optically readable material may comprise two or more optically readable materials. The optically readable material may further comprise the second optically readable material and/or the third optically readable material as defined herein. For example, the optically readable material may comprise the first optically readable material and the second optically readable material; the first optically readable material and the third optically readable material; or the first optically readable material, the second optically readable material, and the third optically readable material.

Preferably, each portion of the coating composition is different. Suitably, a different optically readable material or combination of optically readable materials may be added to each portion. For example, the first optically readable material may be added to a first portion of the coating composition and the second optically readable material may be added to a second portion of the coating composition. The third optically readable material may be added to a third portion of the coating composition, or the third optically readable material may be added to the second portion of the coating composition comprising the second optically readable material.

A solvent may be added to one or more of the portions of the coating composition. Preferably, the solvent is mixed with an optically readable material before being added to the portion of the coating composition. In some embodiments, each optically readable material is mixed with a solvent before being added to a portion of the coating composition. In some embodiments, none of the optically readable materials are mixed with a solvent. In some embodiments, some of the optically readable materials are mixed with a solvent and some of the optically readable materials are not mixed with a solvent before being added to a portion of the coating composition. For example, the first optically readable material may be mixed with a solvent before being added to a first portion of the coating composition, and the first optically readable material may be added to a second portion of the coating composition without being mixed with a solvent beforehand.

Preferably, the first optically readable material is not mixed with a solvent before being added to the first portion of the coating composition. Preferably, the second optically readable material is mixed with a solvent before being added to the second portion of the coating composition. Preferably, the third optically readable material is not mixed with a solvent before being added to the second or third portion of the coating composition.

If two or more optically readable materials are added to one portion of the coating composition, the solvent may be mixed with one of the optically readable materials before being added to the portion of the coating composition and the other optically readable material(s) may be added to the portion of the coating composition without being mixed with a solvent beforehand. For example, the second optically readable material may be mixed with a solvent before being added to the second portion of the coating composition and the third optically readable material may be added to the second portion of the coating composition without being mixed with a solvent beforehand.

The solvent mixed with an optically readable material before being added to a portion of the coating composition may comprise a polar solvent and/or a non-polar solvent. Preferably the solvent comprises a polar solvent. The solvent may comprise an organic solvent and/or an inorganic solvent. The solvent may comprise a mixture of an organic solvent and an inorganic solvent, such as water. Preferably the solvent comprises an organic solvent. The organic solvent suitably comprises a polar organic compound having 6 or fewer carbon atoms. The organic solvent may comprise an alcohol and/or a ketone. Suitable examples of organic solvents include ethanol, propanol, isopropyl alcohol and acetone. Ethanol is preferred.

The portions of the coating composition may be combined with mixing.

In some embodiments, the first optically readable material and the mixture containing the second optically readable material, the third optically readable material, if present, and the solvent may be added to separate portions of the coating composition which are then combined. One advantage of this is that the second optically readable material and third optically readable material, if present, may be uniformly mixed into the coating composition without affecting the non-uniform distribution of the first optically readable material in the coating composition.

The method of the first aspect may comprise:
(a) providing a first portion and a second portion of a coating composition;
(b) adding a first optically readable material to the first portion of the coating composition;
(c) adding a second optically readable material to a solvent to form a mixture;
(d) adding the mixture to the second portion of the coating composition;
(e) combining the first portion and the second portion of the coating composition.

The first portion and the second portion may be combined with mixing. They may be combined at any suitable ratio. The first portion and the second portion may be combined in a ratio of from 1:10 to 10:1, such as from 1:5 to 5:1, such as from 1:3 to 1:1, by volume.

According to a second aspect of the present invention, there is provided a method of producing an optically readable PUF, comprising producing an optically readable PUF coating composition in accordance with the method of the first aspect and applying the optically readable PUF coating composition to a substrate.

The method of the second aspect may further comprise drying or curing the optically readable PUF coating composition.

According to a third aspect of the present invention, there is provided an optically readable PUF coating composition produced according to the method of the first aspect.

According to a fourth aspect of the present invention, there is provided an optically readable PUF produced according to the method of the second aspect.

The optically readable PUF may be used as a security element. The optically readable PUF may include an alignment mark, to allow an optical reader to use that mark to correct for scale, perspective and any transforms (e.g. mirror image) that may be applied as part of the reading of the PUF.

A ‘unique’ identity, e.g. serial number, may be printed adjacent to the optically readable PUF to enable further authentication of the PUF.

According to a fifth aspect of the present invention, there is provided an article comprising a layer, the layer providing a primary function, wherein the layer comprises an optically readable PUF which provides a secondary function of enabling authentication of the article.

The article of the fifth aspect comprises a functional layer with an integrated optically readable PUF. This advantageously allows the manufacture of the article to be simplified, since the functional layer and the optically readable PUF may be prepared in a single step, as opposed to requiring the optically readable PUF to be applied to the functional layer in a separate step, for example as an adhesive label.

The primary function may be the Improvement of a property of the article. For example, the primary function may be the improvement of strength, durability, appearance, surface texture, taste, and/or smell of the article.

The article may be any article which would benefit from the authentication function provided by the optically readable PUF. The article may be selected from machine or device parts, clothing, footwear, accessories, bags, food, artwork, electronic components, certificates, ID cards, consumable goods, gemstones, medicine, tax stamps, currency, packaging and labelling. For example, the article may be branded clothing and the optically readable PUF may enable its authentication as a genuine article. As another example, the article may be a medicinal tablet and the PUF may enable the authentication of the tablet as genuine.

In one embodiment, the article is food or medicine and the layer is edible. Suitably, the layer is digestible and non-toxic.

The optically readable PUF is suitably present in substantially the entire layer. This may allow any part of the layer to be used to authenticate the article. Suitably, at least 95%, such as at least 98%, such as at least 99% by surface area of the layer comprises the optically readable PUF. Preferably, 100% by surface area of the layer comprises the optically readable PUF.

The layer suitably forms a major surface of the article. The layer may form at least 10%, such as at least 30%, such as at least 50% the surface area of the article. The layer may form 100% of the surface area of the article. In one embodiment, the article is food or medicine and the layer forms 100% of the surface area of the article.

A portion of the layer comprising at least a portion of the optically readable PUF may be designated as an optically readable area. This may be useful to improve the reliability of readings of the optically readable PUF, as readings taken from different parts of the layer may not be comparable. The layer may include an alignment mark, to allow an optical reader to use that mark to correct for scale, perspective and any transforms (e.g. mirror image) that may be applied as part of the reading of the PUF.

A ‘unique’ identity, e.g. serial number, may be printed adjacent to the optically readable area to enable further authentication of the PUF.

The layer suitably comprises a polymer. The polymer may act as a binder to allow the layer to adhere to the article.

The optically readable PUF suitably comprises an optically readable material. The optically readable material may be non-uniformly distributed in the optically readable PUF.

The optically readable material may comprise any suitable material that can be detected by optical means. The optically readable material may comprise a quantum dot, a quantum wire, a flake or layer of a substantially two-dimensional material, a metallic nanoparticle, a coloured compound and/or a fluorescent compound. Preferably, the optically readable material comprises a quantum dot, a quantum wire, a flake or layer of a substantially two-dimensional material, a metallic nanoparticle, and/or a fluorescent compound. The optically readable material may emit radiation at a single wavelength, or the optically readable material may emit radiation with different wavelengths, for example corresponding to a variation in band gap of the optically readable material. The optically readable material may therefore be an emitter of electromagnetic radiation, or in other words a material configured or generally able to emit electromagnetic radiation when excited, for example by excitation electromagnetic radiation.

In some embodiments, the optically readable material comprises a quantum dot, a quantum wire, a flake or layer of substantially two-dimensional material, and/or a metallic nanoparticle. The optically readable material may comprise a plurality of quantum dots, quantum wires, flakes or layers of two-dimensional material, and/or metallic nanoparticles.

In some embodiments, the optically readable material comprises a coloured compound.

In some embodiments, the optically readable material comprises a fluorescent compound. The fluorescent compound may comprise a small molecule. The fluorescent compound suitably comprises a polyunsaturated compound, for example a polyaromatic compound. Suitable examples of fluorescent compounds include rhodamine dyes, cyanine dyes, phthalocyanine dyes, porphyrin dyes, and quinacridones. Rhodamine dyes and cyanine dyes are preferred. The rhodamine dye may be selected from Rhodamine 6G, Rhodamine 123 and/or Rhodamine B. The cyanine dye may be selected from Cy2, Cy3, Cy3.5, Cy5, C5.5, Cy7 and/or Cy7.5.

Suitably, the layer has been applied in a single step.

In some embodiments, the optically readable PUF is as defined by the fourth aspect of the present invention.

According to a sixth aspect of the present invention, there is provided a method of making an article according to any preceding claim, the method comprising providing a layer for the article, wherein the layer provides a primary function, and wherein the layer comprises an optically readable PUF which provides a secondary function of enabling authentication of the article.

Suitable features of the article, the layer, and the optically readable PUF are as described in relation to the fifth aspect.

Providing the layer for the article may comprise applying a coating composition to a substrate.

The coating composition may be dried or cured. The coating composition may comprise the optically readable PUF coating composition of the third aspect.

### BRIEF DESCRIPTION OF THE DRAWINGS

For a better understanding of the invention, and to show how embodiments of the same may be carried into effect, reference will now be made, by way of example, to the accompanying Figures in which:

FIG. 1 depicts flash photographs taken of (a) a tag formed from Ink A, and (b) a tag formed from Ink C, wherein Ink C is an optically readable PUF according to the fourth aspect of the present invention; and

FIG. 2 depicts identities created from the (a) a tag formed from Ink A, and (b) a tag formed from Ink C, wherein Ink C is an optically readable PUF according to the fourth aspect of the present invention.

FIG. 3 schematically depicts general methodology associated with the method of the first aspect of the present invention.

FIG. 4 schematically depicts different methodology associated with example embodiments.

FIG. 5 schematically depicts general methodology associated with the method of the second aspect of the present invention.

FIG. 6 schematically depicts an article according to the fifth aspect of the present invention.

FIG. 7 schematically depicts general methodology associated with the method of the sixth aspect of the present invention.

### EXAMPLES

### Definitions

Inter-Hamming distance (inter-HD): the number of bits that differ between two identities extracted from two different tags, divided by the total number of bits within an identity. The ideal value is 0.5.

Intra-Hamming distance (intra-HD): the number of bits that differ between two identities extracted from the same tag, divided by the total number of bits within an identity.

Uniformity: the ratio of 0's to 1's in the identity. The ideal value is 0.5.

Degrees of Freedom (DOF): the maximum number of bits needed to completely specify an identity. A high DOF is desirable. Decidability: a measure of the separation of the inter and intra hamming distance distributions. A high decidability is desirable.

### Example 1

Rhodamine 6G was dispersed in ethanol forming a 100 mg/ml solution. 25 μl of this solution was added to a UV curable lacquer and mixed for 15 minutes using a mixing bit rotating at 400 RPM to form Ink A comprising Rhodamine 6G at a concentration of 2.5 mg/ml.

Rhodamine B was added directly to a UV curable lacquer and mixed for 5 minutes using a mixing bit rotating at 400 RPM to form Ink B comprising Rhodamine B at a concentration of 2.5 mg/ml.

Ink B was mixed with Ink A in a volume ratio of 1:3 for 5 minutes using a mixing bit rotating at 400 RPM to form Ink C.

### Example 2

Rhodamine 6G was added directly to a UV curable lacquer and mixed for 5 minutes using a mixing bit rotating at 400 RPM to form Ink A comprising Rhodamine 6G at a concentration of 0.1 mg/ml.

Rhodamine 6G was dispersed in ethanol forming a 100 mg/ml solution. 50 mg of quinacridone was mixed with 1 ml of the solution to form a mixture comprising 2 parts Rhodamine 6G to 1 part quinacridone by weight.

The mixture was added to Ink A and mixed for 15 minutes using a mixing bit rotating at 500 RPM to form Ink B.

### Example 3

Ink A and Ink C from Example 1 were separately coated onto substrates and cured for 60 seconds using a Hg vapour UV lamp to form tags.

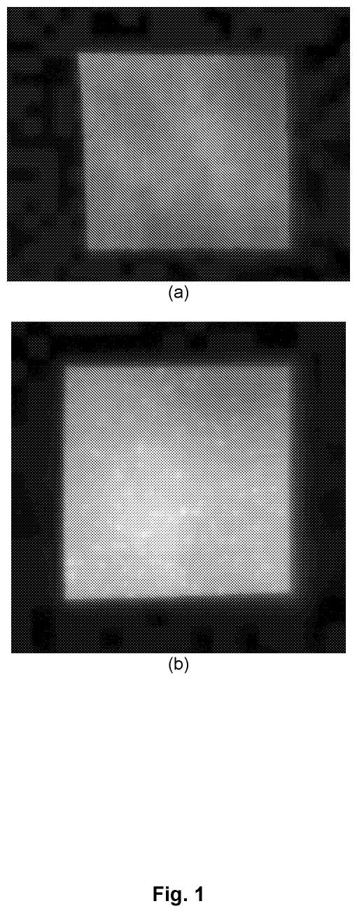

Emission from the tags was measured by flash photographing the tags using a smartphone camera. The photographs are shown in FIG. 1. Background emission from uniformly dispersed Rhodamine 6G is visible over the entirety of the tags formed from Ink A (FIG. 1(a)) and Ink C (FIG. 1(b). Spots of non-uniformly dispersed Rhodamine B are visible in the tag formed from Ink C.

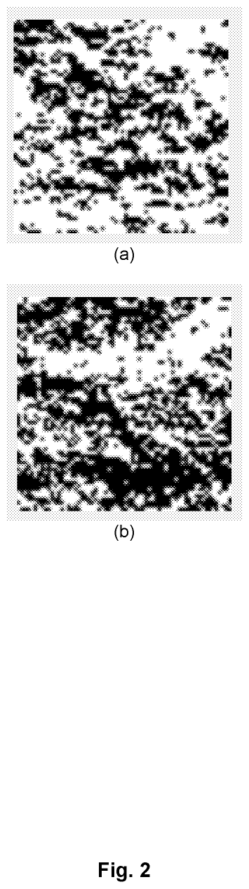

An identity was created using an image of each tag as the source. These identities are shown in FIG. 2. FIG. 2(a) corresponds to Ink A and FIG. 2(b) corresponds to Ink C.

The figures of merit for the two identities in FIG. 2 are shown in the following table:

| Ink | A | C |
|---|---|---|
| Inter-HD (average, standard | 0.476, 0.015 | 0.488, 0.005 |
| deviation): | | |
| Intra-HD (average, standard | 0.406, 0.028 | 0.383, 0.025 |
| deviation) | | |
| Uniformity | 0.65 | 0.49 |
| Degrees of Freedom (bits) | 1100 | 1468 |
| Decidability | 3.78 | 5.67 |

The inter-HD values were produced through the comparison of a number of tags generated for each type (A and C). Ink C generally showed superior figures of merit compared to Ink A.

### DETAILED DESCRIPTION OF THE EXAMPLE EMBODIMENTS

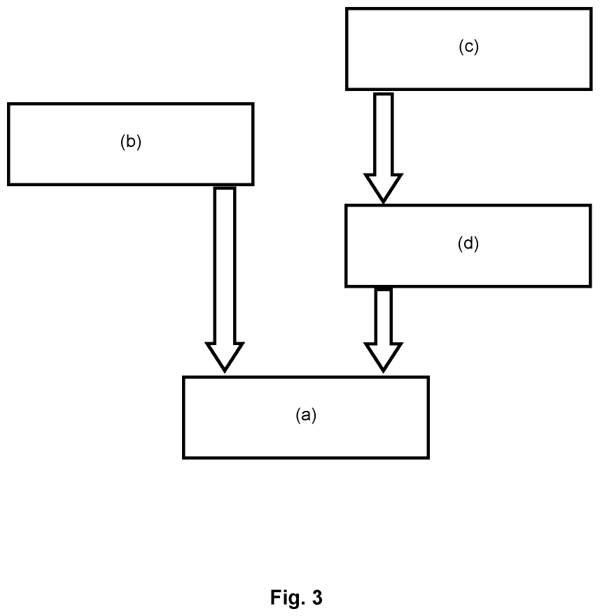

FIG. 3 schematically depicts methodology for making an optically readable PUF coating composition. Initially, a coating composition is provided, (a). A first optically readable material is added to the coating composition, (b). A second optically readable material and a solvent are mixed to form a mixture, (c). The mixture is added to the coating composition, (d).

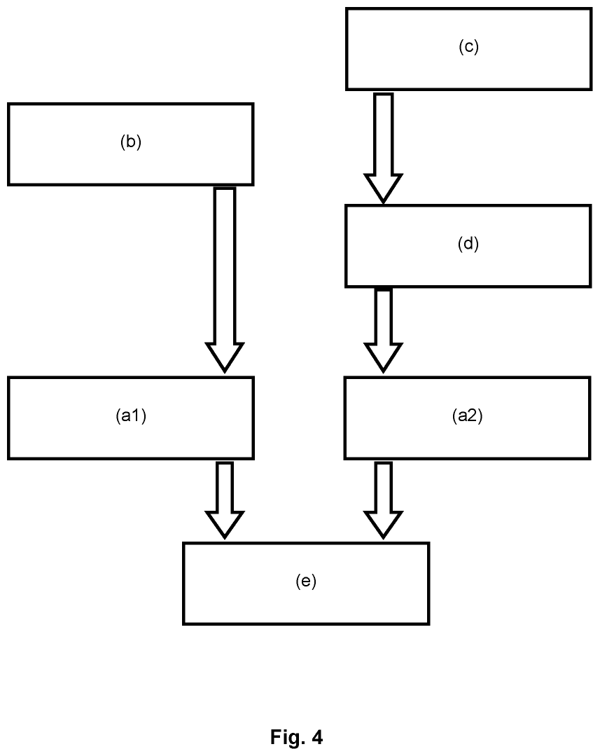

FIG. 4 schematically depicts a preferred methodology for making an optically readable PUF coating composition. Initially, a coating composition is provided in a first portion (a1) and a second portion (a2). A first optically readable material is added to the first portion of the coating composition, (b). A second optically readable material is added to a solvent to form a mixture, (c). The mixture is added to the second portion of the coating composition, (d). The first portion and the second portion of the coating composition are combined, (e).

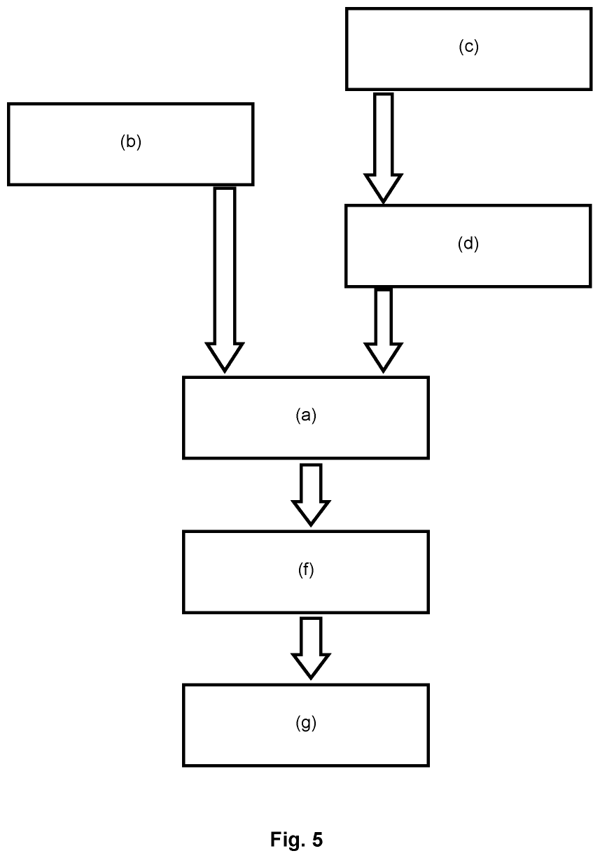

FIG. 5 schematically depicts methodology for producing an optically readable PUF. Initially, a coating composition is provided, (a). A first optically readable material is added to the coating composition, (b). A second optically readable material and a solvent are mixed to form a mixture, (c). The mixture is added to the coating composition, (d). Following steps (b) and (d), which may be carried out in any order, the coating composition is applied to a substrate, (f). The coating composition may be dried or cured following application to the substrate, (g).

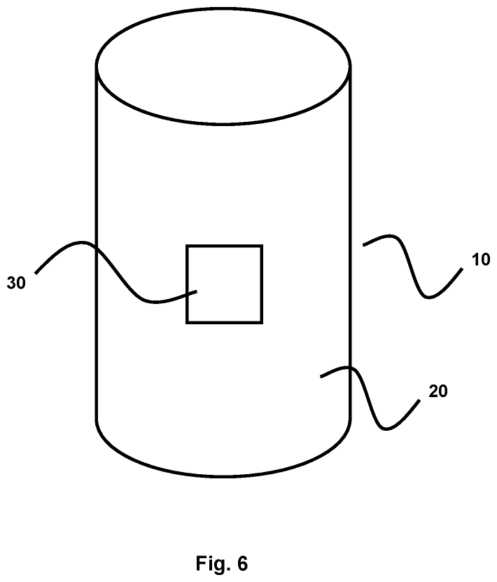

FIG. 6 schematically depicts an article 10 according to the fifth aspect of the present invention. The article 10 comprising a layer 20, the layer 20 providing a primary function, wherein the layer 20 comprises an optically readable PUF which provides a secondary function of enabling authentication of the article. A portion of the layer 20 comprising at least a portion of the optically readable PUF may be designated as an optically readable area 30.

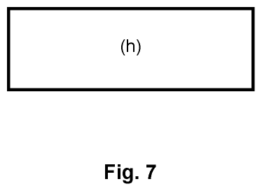

FIG. 7 schematically depicts methodology for making an article. A layer is provided for an article, (h), wherein the layer provides a primary function, and wherein the layer comprises an optically readable PUF which provides a secondary function of enabling authentication of the article.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of making an optically readable PUF coating composition, the method comprising increasing the entropy of a coating composition by adding a first optically readable material to the coating composition.

2. The method of claim 1, wherein the coating composition is a lacquer.

3. The method of claim 1, comprising non-uniformly dispersing the first optically readable material in the coating composition.

4. The method of claim 1, wherein the first optically readable material includes a fluorescent compound.

5. The method of claim 4, wherein the fluorescent compound includes at least one of a rhodamine dye, a cyanine dye, a phthalocyanine dye, a porphyrin dye, or a quinacridone.

6. The method of claim 1, further comprising mixing a second optically readable material and a solvent to form a mixture and adding the mixture to the coating composition.

7. The method of claim 6, comprising uniformly mixing the second optically readable material and the solvent.

8. The method of claim 6, wherein the solvent includes at least one of an alcohol or a ketone.

9. (canceled)

10. The method of claim 1,
wherein adding a first optically readable material to the coating composition further includes:
providing a first portion and a second portion of the coating composition;
adding the first optically readable material to the first portion of the coating composition;
adding a second optically readable material to a solvent to form a mixture;
adding the mixture to the second portion of the coating composition; and
combining the first portion and the second portion of the coating composition.

11. A method comprising:
increasing the entropy of a coating composition by adding a first optically readable material to the coating composition to yield an optically readable PUF coating composition; and
applying the optically readable PUF coating composition to a surface.

12. The method of claim 11, further comprising drying or curing the optically readable PUF coating composition.

13. (canceled)

14. (canceled)

15. The method of claim 1, further comprising:
increasing the entropy of the coating composition by adding an optically readable material to at least two portions of the coating composition; and
combining the at least two portions of the coating composition.

16. The method of claim 15, further comprising adding a solvent to each of the at least two portions of the coating composition.

17. A structure comprising:
an optically readable PUF coating composition;
a first optically readable material within the coating composition, wherein the first optically readable material increases the entropy of the coating composition.

18. The structure of claim 17, wherein the coating composition is a lacquer.

19. The structure of claim 17, wherein the first optically readable material is non-uniformly dispersed in the coating composition.

20. The structure of claim 17, wherein the first optically readable material includes a fluorescent compound.

21. The structure of claim 21, wherein the fluorescent compound includes at least one of a rhodamine dye, a cyanine dye, a phthalocyanine dye, a porphyrin dye, or a quinacridone.

22. The structure of claim 17, wherein the coating composition further includes a second optically readable material mixed with a solvent.

23. The structure of claim 17, wherein the optically readable PUF coating composition is applied to a surface and cured.
